(19) United States
(12) Patent Application Publication
(10) Pub. No.: US 2015/0276647 A1
(43) Pub. Date: Oct. 1, 2015

(54) AMPEROMETRIC NITRATE SENSOR

(71) Applicant: KING FAHD UNIVERSITY OF PETROLEUM AND MINERALS, DHAHRAN (SA)

(72) Inventors: ABDEL-NASSER METWALLY ALY KAWDE, DHAHRAN (SA); MD ABDUL AZIZ, DHAHRAN (SA)

(73) Assignee: KING FAHD UNIVERSITY OF PETROLEUM AND MINERALS, DHAHRAN (SA)

(21) Appl. No.: 14/242,254

(22) Filed: Apr. 1, 2014

(51) Int. Cl. G01N 27/30

(52) U.S. Cl. CPC G01N 27/30

(57) ABSTRACT

The amperometric nitrate sensor is a graphite pencil electrode (GPE) having an outer surface electrodeposited (coated) with a layer of cobalt, wherein the layer of cobalt is nanostructured. The graphite pencil electrode modified with nano cobalt may be used for detection and sensing nitrate ions (NO₃⁻). The graphite pencil electrode modified with cobalt is prepared by immersing a pencil graphite electrode in an electrodeposition solution that is prepared by mixing CoCl₂ in a solution of potassium chloride; and applying an electrical potential of approximately −1.3 V for 120 seconds across the graphite pencil electrode to form a graphite pencil electrode modified with nano cobalt. The graphite pencil electrode coated with nanostructured cobalt is then removed from the mixture, washed and dried, and is then ready to be used for the amperometric sensing and quantification of nitrate ions.

### BACKGROUND OF THE INVENTION

1. Field of the Invention

The present invention relates to the electrochemical detection and quantization of analytes, and particularly to an amperometric nitrate sensor in the form of a pencil graphite electrode modified with nanostructured cobalt.

2. Description of the Related Art

Nitrate (NO₃⁻) is an inorganic anion that is used vigorously in agriculture, food, and various industries. Moreover, the natural nitrogen cycle produces nitrate. As a result, nitrate is haphazardly distributed in the environment, especially in water. Previous studies proved that an excess amount of nitrate in water can present environmental and physiological problems. For instance, the presence of an excess amount of nitrate can lead to algal blooms and eutrophication, which may have serious effects on the ecological balance in nature. Moreover, the presence of an excess amount of nitrate in drinking water can cause cancer, since nitrate can be reduced easily to nitrite, and subsequent nitrosation reactions give rise to N-nitroso compounds that are highly carcinogenic. Because of its role in ecosystem dynamics and its potential impact on human health, the U.S. Environmental Protection Agency (EPA) recommends that the nitrate levels in drinking water should not exceed 10 mg/L. Therefore, the determination of nitrate is of prime importance in areas of human health and environmental protection.

Several methods have been developed for the measurement of nitrate, such as ultraviolet (UV) spectrometry, chemiluminescence, fluorimetry, chromatography and capillary electrophoresis. However, almost all of these methods require expensive and massive instrumentation. As a result, those methods are not suitable for routinely monitoring the concentration of nitrate at field level. Compared to other methods, electrochemical determination of any analyte is advantageous due to its simplicity, portability, fast response times, good sensitivity and high selectivity. However, the electrode is usually modified with an electrocatalyst or electron mediator to detect the analyte of interest, as most conventional electrodes show slow kinetics of the heterogeneous electron transfer. In this regard, numerous kinds of nanostructured materials have been extensively used as electrocatalysts or electron mediators due to their unique properties, e.g., excellent electrocatalytic properties, high surface-to-volume ratio, high selectivity, and conductivity. In light of the unique properties of nanostructured materials, there have been several reports for the preparation of nanostructured material-modified electrodes for nitrate reduction. However, not all of these modified electrodes are cost effective, as those preparations require expensive chemicals and substrate electrode, and involve multiple steps.

Among the common substrate electrodes, pencil graphite electrodes (hereinafter, GPEs) are common electrodes used in a variety of fields, such as electrochemistry, particularly for the electrochemical quantification of various analytes, such as trace metals, organic compounds and nucleic acids, Unfortunately, GPEs show poor electrocatalytic properties toward many electroactive molecules. It is generally known that high electrocatalytic property is required to fabricate a sensitive electrochemical sensor. As a result, modification of a GPE with a low-cost electrocatalyst in a single step and in a short period of time to obtain a low cost and high catalytic electrode appears to be logical.

Thus, an amperometric nitrate sensor solving the aforementioned problems is desired.

### SUMMARY OF THE INVENTION

The amperometric nitrate sensor is a disposable graphite pencil electrode (GPE) having an outer surface electrodeposited (coated) with a layer of cobalt, wherein the layer of cobalt is nanostructured. The graphite pencil electrode modified with nano-cobalt may be used for the detection and sensing of nitrate ions (NO₃⁻). The graphite pencil electrode modified with cobalt is prepared by immersing a graphite pencil electrode into an electrodeposition solution that is prepared by mixing CoCl₂ in 0.1 M KCl solution and applying an electrical potential of about −1.3 V for approximately 120 seconds across the graphite pencil electrode to form a graphite pencil electrode modified with nano-cobalt. The graphite pencil electrode coated with nanostructured cobalt is then removed from the mixture, washed, and dried, and is then ready to be used for the amperometric sensing and quantification of nitrate ions.

These and other features of the present invention will become readily apparent upon further review of the following specification and drawings.

### BRIEF DESCRIPTION OF THE DRAWINGS

FIG. 1A shows cyclic voltammograms (CVs) in aqueous 0.1 M KCl in the absence (a) and presence (b) of 5 mM NaNO₃ at an Au (gold) electrode at a scan rate of 100 mV/s.

FIG. 1B shows cyclic voltammograms (CVs) in aqueous 0.1 M KCl in the absence (a) and presence (b) of 5 mM NaNO3 at Pt (platinum) disk electrode at a scan rate of 100 mV/s.

FIG. 1C shows cyclic voltammograms (CVs) in aqueous 0.1 M KCl in the absence (a) and presence (b) of 5 mM NaNO₃ at a glassy carbon disk electrode (GCE) at a scan rate of 100 mV/s.

FIG. 1D shows cyclic voltammograms (CVs) in aqueous 0.1 M KCl in the absence (a) and presence (b) of 5 mM NaNO₃ at a graphite pencil electrode (GPE) at a scan rate of 100 mV/s.

FIG. 2 shows the cyclic voltammograms (CVs) in 0.1 M KCl at a scan rate of 100 mV/s in the absence (curve a) and the presence (curve b) of 5 mM NaNO₃ using an amperometric nitrate sensor according to the present invention made by electrodepositing a nano-cobalt layer on a graphite pencil electrode at −1.3 V for 120 seconds.

FIG. 3A shows amperometric responses of an amperometric nitrate sensor according to the present invention in an aqueous solution of 0.5 mM NaNO₃ in 0.1 M KCl at different applied detection potentials of (a) −0.9 V (b) −1.0 V and (c) −1.1 V, together with an inset showing the corresponding plot of the amperometric current versus the applied potential.

FIG. 3B shows amperometric responses of an amperometric nitrate sensor according to the present invention at −1.0 V applied detection potential in an aqueous solution of 0.5 mM NaNO₃ in 0.1 M KCl at different applied cobalt deposition potentials of (a) −0.9 V (b) −1.0 V and (c) −1.1 V and (d) −1.5 V respectively, together with an inset showing the corresponding plot of the amperometric current versus the applied potential used for deposition of cobalt on the GPE.

FIG. 3C shows amperometric responses of an amperometric nitrate sensor according to the present invention at −1.0 V applied detection potential in an aqueous solution of 0.5 mM NaNO₃ in 0.1 M KCl using an amperometric nitrate sensor according to the present invention prepared at different cobalt concentrations of (a) 25 mM (b) 50 mM (c) 100 mM and (d) 150 mM respectively, together with an inset showing the corresponding plot of the amperometric current as a function of the concentration of cobalt used during deposition of cobalt on the GPE.

FIG. 3D shows amperometric responses of an amperometric nitrate sensor according to the present invention at −1.0 V applied detection potential in an aqueous solution of 0.5 mM NaNO₃ in 0.1 M KCl for amperometric nitrate sensor according to the present invention prepared with different deposition times of (a) 30 s (b) 60 s (c) 120 s and (d) 180 s, respectively, together with an inset showing the corresponding plot of the amperometric current versus the deposition time.

FIG. 4A shows FE-SEM images at three different magnifications: (1) 200 μm; (2) 50 μm; and (3) 500 nm of an amperometric nitrate sensor according to the present invention.

FIG. 4B shows FE-SEM images at three different magnifications: (1) 200 μm; (2) 50 μm; and (3) 500 nm of a bare (unmodified) GPE.

FIG. 5 shows typical amperometric responses of an amperometric nitrate sensor according to the present invention at −1.0 V applied potential upon successive additions of 20 μm (NaNO₃), together with an inset showing the corresponding calibration plot of current as a function of nitrate concentration.

FIG. 6 shows the amperometric responses measured in 0.1 M KCl at −1.0 V of an amperometric nitrate sensor according to the present invention to successive additions of NaNO₃, Na₂SO₄, Na₃PO₄, Na₂CO₃, and NaNO₂ at −1.0 V in 0.1 M KCl.

Similar reference characters denote corresponding features consistently throughout the attached drawings.

### DETAILED DESCRIPTION OF THE PREFERRED EMBODIMENTS

The amperometric nitrate sensor is based on the application of a nano-cobalt-modified graphite pencil electrode as an efficient electrode material for the analytical detection of low nitrate ion (NO₃⁻) concentrations. The graphite pencil electrode (GPE) has an outer surface coated with a layer of cobalt (which is nanostructured or nanoparticulate cobalt) having a thickness of less than 50 nanometers.

The cobalt-modified GPE amperometric nitrate sensor may be prepared as follows. A 10 mm bare graphite pencil electrode (GPE) from a graphite pencil was immersed in a solution of 0.1 M KCl containing CoCl₂. A counter electrode, reference electrode and the GPE as working electrode were connected to a CHI 660C instrument. An electrical potential of approximately −1.3 V was applied for about 120 seconds for electrodeposition of cobalt on the surface of the PGE to form a porous and nanostructured layer thereon. The graphite pencil electrode coated with nanostructured cobalt was then removed from the mixture, and washed by gentle dipping two times into deionized water. The entire electrochemical measurement was performed just after preparation of the modified electrode and is ready to be used for the electrochemical detection and quantification of nitrate ions.

As will be described in detail below, various concentrations of CoCl₂ and various electrodeposition potentials and times were experimented to prepare a cobalt-modified GPE for checking the effect on the amperometric signal of 0.5 mM NaNO₃.

### Example 1

### Electrochemical Properties of Conventional Electrodes Toward Nitrate Reduction

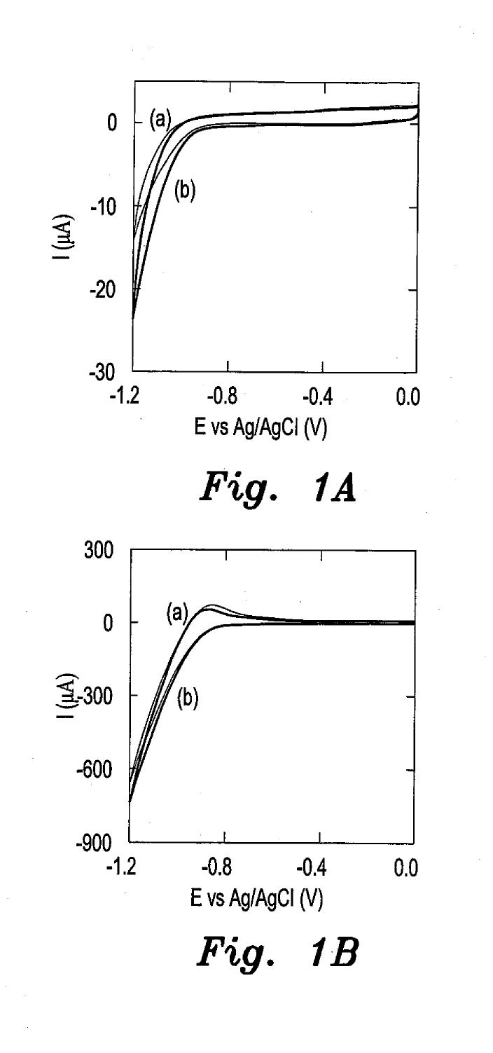

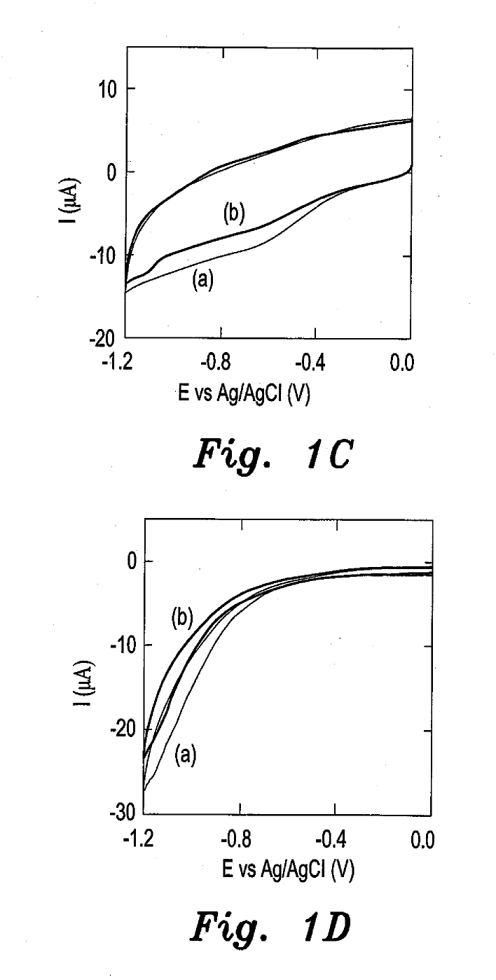

Electrochemical properties of conventional electrodes toward nitrate reduction were investigated. FIGS. 1A-1D present the CVs in aqueous solution of 0.1 M KCl in the absence (a) and presence (b) of 5 mM NaNO₃ at different conventional electrodes. As illustrated, at a gold (Au) electrode (FIG. 1A), there is no significant difference between the voltammograms in the absence (FIG. 1A, curve a) and presence (FIG. 1A, curve b) of 5 mM NaNO₃ at applied potential greater than −1.0 V. At a potential less than −1.0 V, there is a small current representing reduction. However, this reduction current is not enough to fabricate a sensitive electrochemical sensor, since that potential has high background current (FIG. 1A, curve a). Similarly, at the platinum (Pt) electrode, as shown in FIG. 1B, there is almost no difference between the cyclic voltammograms (CVs) in the absence (FIG. 1B, curve a) and presence (FIG. 1B, curve b) of 5 mM NaNO₃ in the entire tested potential window. This result demonstrated that the platinum (Pt) electrode cannot reduce the nitrate at tested potential windows. Moreover, CVs at both a glassy carbon electrode (FIG. 1C) and unmodified GPE (FIG. 1D) in 0.1 M KCl in the presence of 5 mM NaNO₃ (curve b) show lower reduction currents than in the absence of 5 mM NaNO₃ (curve a). This behavior is unusual and confirms that widely used conventional electrodes (Au, Pt, GCE and GPE) cannot be used for the fabrication of a sensitive electrochemical nitrate sensor.

### Example 2

### Electrochemical Reduction of Nitrate at Cobalt-Modified GPE

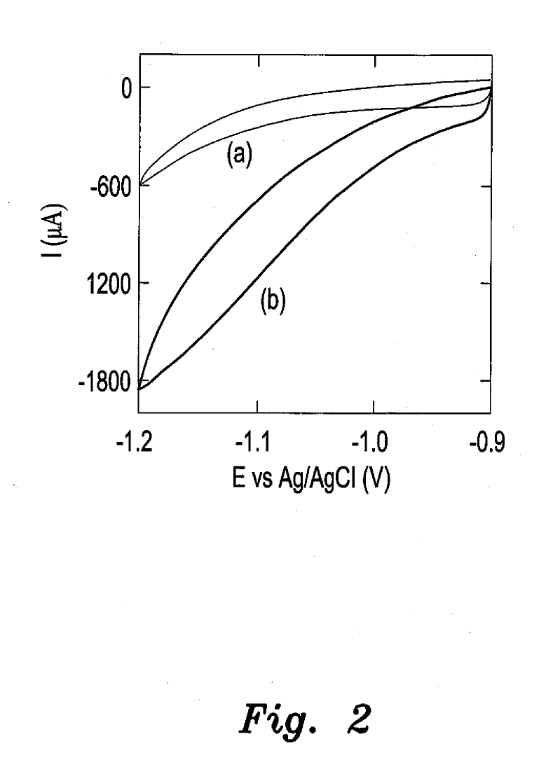

Electrochemical reduction of nitrate was investigated at the cobalt-modified GPE (the amperometric nitrate sensor). FIG. 2 shows the cyclic voltammograms (CVs) of the Co-modified GPE in 0.1 M KCl in the absence (FIG. 2, curve a) and the presence (FIG. 2, curve b) of 5 mM NaNO₃. The CVs of FIG. 2, curve “a” and curve “b” confirm that a Co-modified GPE can reduce the 4-NP from the starting of the CV (i.e., −0.9 V), and that the reduction current of 5 mM NaNO₃ is increased with a decrease in the potential. It is noteworthy that the reduction current of nitrate ion is significantly high enough to fabricate a sensitive electrochemical nitrate sensor.

### Example 3

### Optimization of Parameters for Preparation of Nano Cobalt-Modified GPE

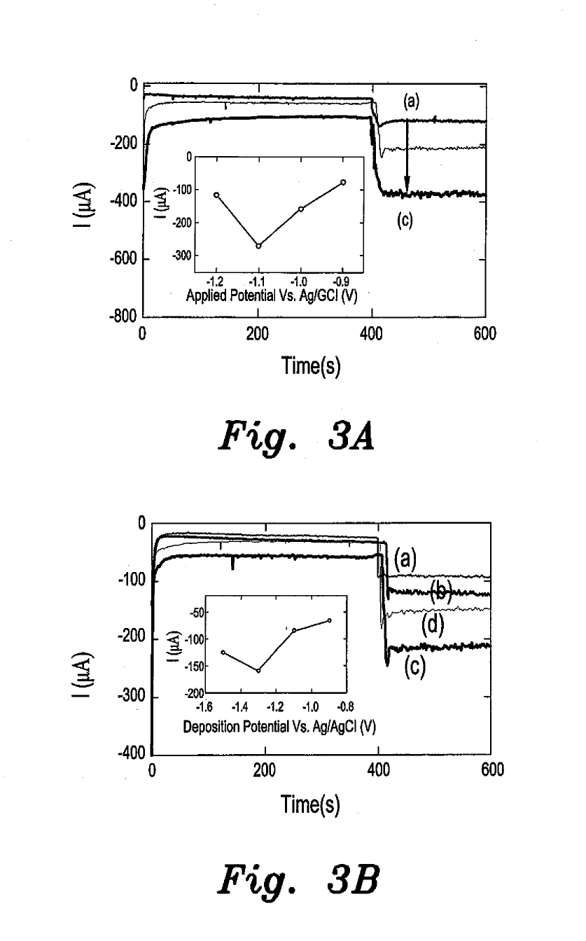

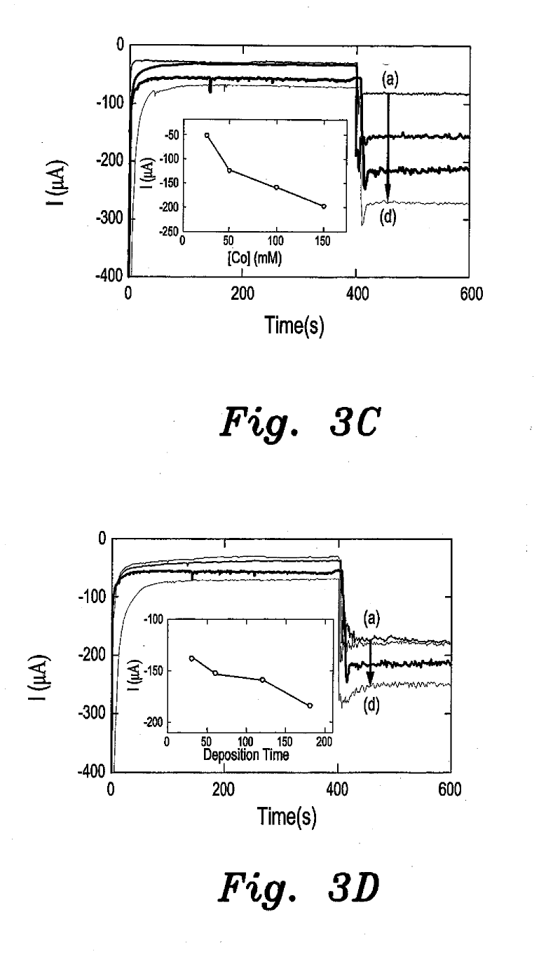

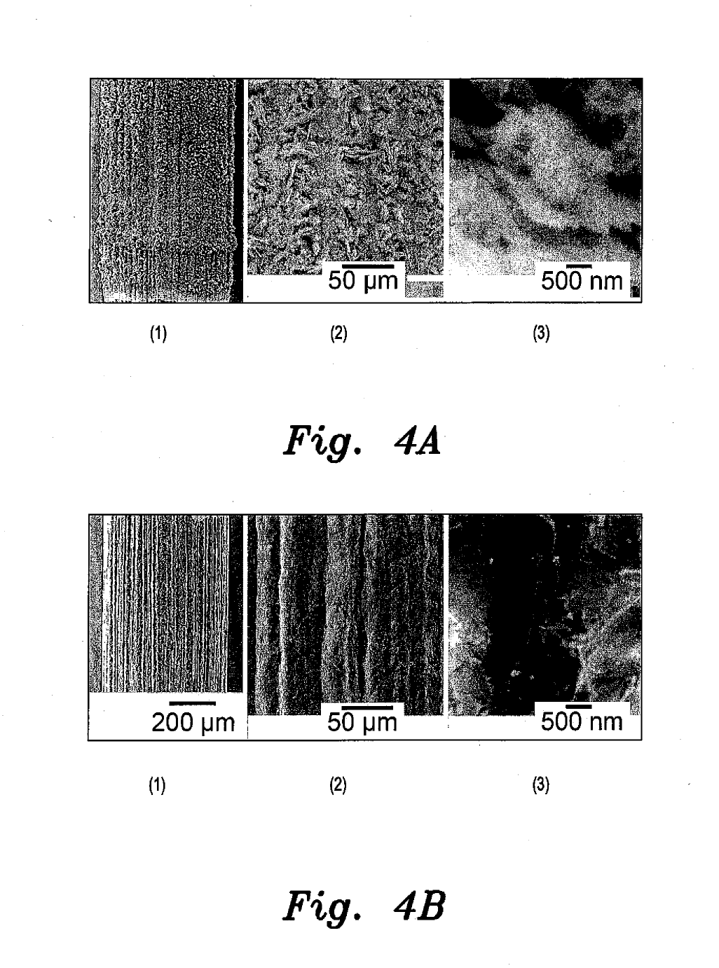

In order to obtain the best condition for nitrate reduction; the preparation conditions of the Co-modified GPE (amperometric nitrate sensor) were optimized. First, the electrodeposition potential was varied at discrete intervals from −0.9 V to −1.5 V at a constant concentration of CoCl₂ (0.1 M) and electrodeposition time of 120 s. FIG. 3B presents the amperograms of a Co-modified GPE prepared at various potentials in 0.1 M KCl upon addition of 0.5 mM NaNO₃, and the inset depicts the corresponding plot of net reduction current vs. electrodeposition potential. The plot clearly indicates that the net reduction signal of the nitrate increases with decreasing the electrodeposition potential until about −1.3 V and then decreases with further a further decrease of the electrodeposition potential (inset of FIG. 3B). From these figures, it is clear that −1.3 V is the optimum potential to prepare the Co-modified GPE for nitrate reduction. Second, selected concentrations of CoCl₂ from 25 mM to 150 mM were used for the electrodeposition of cobalt at a constant applied potential of −1.3 V and a time of 120 s. The amperograms of the modified electrodes in 0.1 M KCl upon addition of 0.5 mM NaNO₃ shows that the reduction signal increases with increasing the concentration of CoCl₂ (FIG. 3C and its inset). However, the Co-modified GPE prepared using 150 mM CoCl₂ is not stable. As a result, 100 mM CoCl₂ was chosen for further experiments. Last, the Co deposition time was varied at discrete intervals from 30 to 180 seconds at a constant electrodeposition potential of −1.3V and a CoCl₂ concentration of 0.1 M. The amperograms of the prepared electrodes in 0.1 M KCl upon addition of 0.5 mM NaNO₃ show that the reduction signal of nitrate is increased with increasing the electrodeposition time (FIG. 3D and its inset). However, the Co-modified GPE prepared using 180 s as the electrodeposition time is not stable. For preparing nano-cobalt-modified GPE, the optimum electrodeposition potential, concentration of CoCl₂, and electrodeposition time were found to be −1.3V, 0.1 M CoCl₂, and 120 s, respectively.

The morphology of the nano cobalt-modified nano cobalt modified GPE was investigated using Field Emission Scanning Electron Microscopy FE-SEM. FIGS. 4B and 4A show a comparison of the FE-SEM images at different magnification of an unmodified GPE and the cobalt-modified GPE prepared at the optimum conditions described in Example 3, respectively. FIG. 4A indicates that Co was deposited on the GPE at optimum conditions. By comparing FIG. 4B with FIG. 4A, it is clear that cobalt was deposited as a three-dimensional nanostructure on the pencil graphite electrode with high porosity at optimum deposition conditions. Some of the nanostructured cobalt is leaf-shaped and remains nanostructured cobalt with random interconnections (see SEM (3) of FIG. 4A). The thickness of the nanoplate and randomly interconnected nano-cobalt are less than 50 nm, as shown in the 500 nm magnification of SEM (3) of FIG. 4A. FIG. 4A presents homogeneous distribution of nanoplate and randomly interconnected nano-cobalt in the whole modified surfaces of GPE. The cobalt-modified GPE, which has been prepared at optimum conditions, is denoted as “nano-cobalt-GPE”.

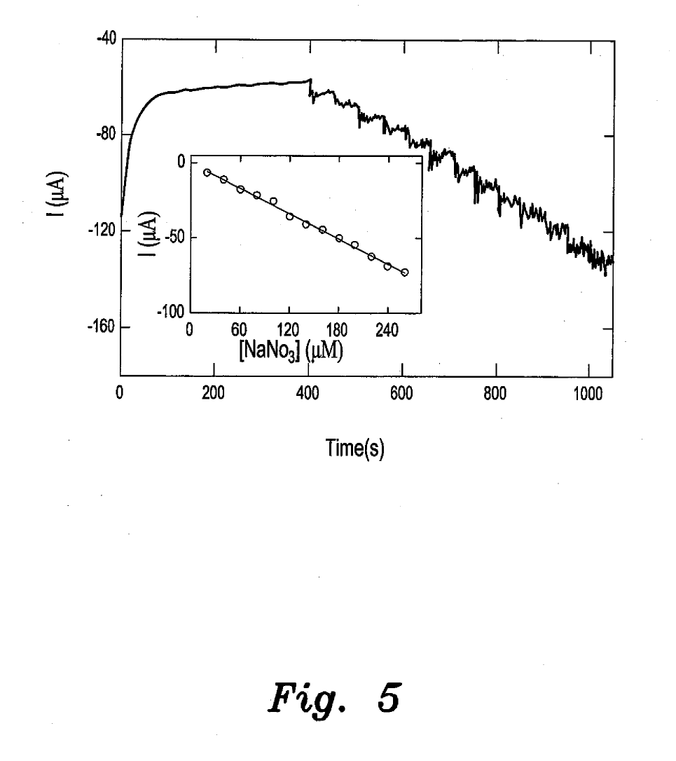

The nitrate concentration-dependent signal and detection limits of the nano-cobalt-GPE prepared at optimum conditions were measured using the amperometric method. FIG. 5 shows typical amperometric responses of the nano-cobalt-GPE at −1.0 V upon successive additions of 20 μM NaNO₃. The nano-cobalt-GPE yielded a well-defined and sensitive signal for each addition of NaNO₃. The concentration-dependent signal (insets in FIG. 5) was linear over the entire nitrate concentration range tested at the nano-cobalt-GPE (R²=0.9960), after subtracting the mean of the corresponding zero NaNO₃ response. The electrodes followed a linear trend that could be fit to the equation y=ax+b. The detection limits of nitrate at an applied potential of −1.0 V at the nano-cobalt-GPE was 5.8 μM. The amperometric nitrate sensor described here is compared with a variety of other nitrate sensors in Table 1, for a variety of electrochemical detection methods, sensing materials, analytical ranges, and detection limits. Table 1 shows that the performance of the sensor developed here was comparable to the performances of other nitrate sensors.

TABLE 1
Comparison of Amperometric Nitrate Sensor With
Other Reported Electrochemical Nitrate Sensors

| | | | | Detec- |
|---|---|---|---|---|
| | | | Linear | tion |
| | Sensing | Sensing | ranges | limit |
| Methods | materials | media | (μM) | (μM) |
| Amperometry | CoNP-GPE | 0.1M KCl | 20-260 | 5.8 |
| Amperometry | PPy-PSS- | 0.10M Na₂SO₄ | — | 30.0 |
| | MWNT- | | | |
| | PEI-CuNP- | | | |
| | rotating disk | | | |
| | electrode | | | |
| Amperometry | PPy nanowire- | — | 1000-4000 | 220.0 |
| | GCE | | | |
| Cyclic | Cone-shaped | 0.5M H₂SO₄ | 100-5000 | 50.0 |
| voltammetry | PPy | | | |
| | nanorod-GCE | | | |
| Linear sweep | Ag nanorod-Au | 0.01M KCl | 100-10000 | 150.0 |
| voltammetry | microelectrode | | | |
| Linear sweep | Nano Cu—Pt | 0.1M Na₂SO₄ | 6.25-300 | 5.0 |
| voltammetry | micro | (pH 2.0). | 300-3500 | |
| | electrode | | | |
| Square wave | Nano Ag on | 0.5M NaCl | 2-1000 | 2.0 |
| voltammetry | Au-IDA | (pH 7.0) | | |
| | microelectrode | | | |
| Square wave | Nano Ag on | 0.5M NaCl | 25-1000 | 10.0 |
| voltammetry | Au-IDA | (pH 7.0) | | |
| | microelectrode | | | |
| Differential | PPy/nano Ag | 0.1M Na₂SO₄. | 1-10000 | 5.0 |
| pulse | composite on | | | |
| voltammetry | GCE | | | |

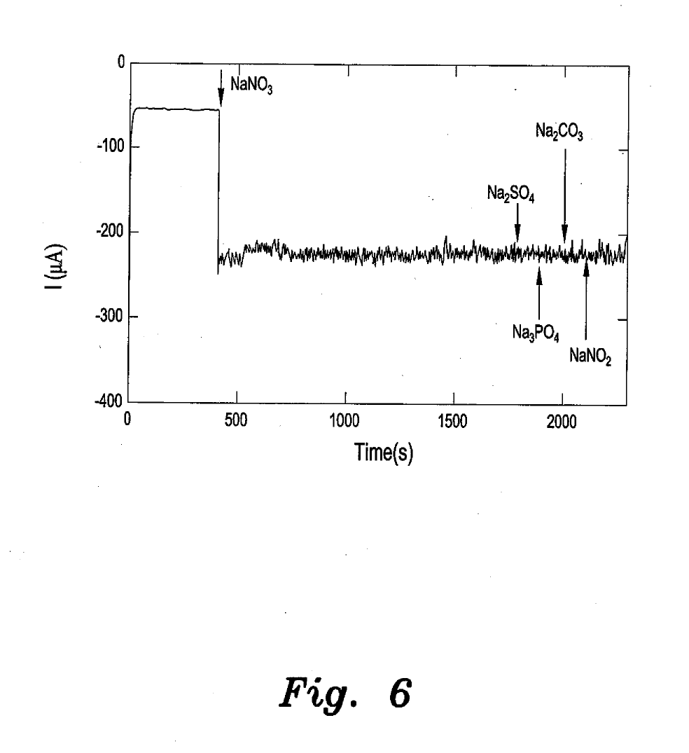

FIG. 6 presents the amperometric response in 0.1 M KCl to successive additions of NaNO₃, Na₂SO₄, Na₃PO₄, Na₂CO₃ and NaNO₂ at −1.0 V at the nano-cobalt GPE surface prepared at optimum conditions. A well-defined nitrate response was observed upon addition of 0.5 mM nitrate. The response remained stable during a prolonged 20.0 min experiment. Afterward, subsequent injections of 100 μM of Na₂SO₄, 100 μM of Na₃PO₄, 100 μM of Na₂CO₃ and 10 μM of NaNO₂ did not produce additional signals, or even modify the obtained current response. Thus, these results reflect good nitrate sensing selectivity and sensitivity at the fabricated nano-cobalt-GPE.

The present inventors have successfully fabricated a novel, extremely low-cost, disposable, and easily fabricated amperometric nitrate sensor based on electrodeposited nano-cobalt on a graphite pencil electrode (GPE) that exhibits excellent electrocatalytic activity towards nitrate reduction. With its remarkable electrocatalytic activity, nano-cobalt on GPE achieves a low detection limit with greater analytical selectivity, sensitivity, and stability than other conventional electrodes. As such, the nano-cobalt-GPE proves to be suitable for the analytical determination of nitrate concentrations in a variety of applications.

It is to be understood that the present invention is not limited to the embodiments described above, but encompasses any and all embodiments within the scope of the following claims.

We claim:

1. An amperometric nitrate sensor comprising a pencil graphite electrode having an outer surface coated with a layer of cobalt.

2. The amperometric nitrate sensor of claim 1, wherein the layer of cobalt is nanostructured.

3. The amperometric nitrate sensor of claim 2, wherein the nanostructured layer of cobalt has a thickness of less than 50 nm.

4. The amperometric nitrate sensor of claim 2, wherein the nanostructured layer of cobalt is leaf shaped.

5. A method of making a pencil graphite electrode modified with cobalt, comprising the steps of:
mixing CoCl₂ in a solution of potassium chloride to make an electrodeposition solution;
immersing a graphite pencil electrode in the electrodeposition solution; and
applying an electrical potential across the graphite pencil electrode to form a graphite pencil electrode modified with nano-cobalt.

6. The method of making a graphite pencil electrode as recited in claim 5, wherein the potassium chloride has a concentration of about 0.1 M.

7. The method of making a graphite pencil electrode as recited in claim 5, wherein the step of applying the electrical potential across the graphite pencil electrode comprises applying an electrical potential of approximately −1.3 V across the graphite pencil electrode to deposit a nano-thin layer of cobalt on the electrode.

8. The method of making a graphite pencil electrode as recited in claim 5, wherein the step of applying the electrical potential across the pencil graphite electrode comprises applying the electrical potential across the pencil graphite electrode for a period of about 30 to 180 seconds.

9. A method of sensing nitrate, comprising the steps of:
bringing an aqueous sample containing nitrate ions into contact with a graphite pencil electrode having a nano-thin layer of cobalt electrodeposited thereon; and
measuring an amperometric response of the nitrate ions.

10. The method of sensing nitrate as recited in claim 9, wherein said step of measuring an amperometric response further comprises the step of applying an electrical potential across the modified graphite pencil electrode to produce the amperometric response.

11. The method of sensing nitrate according to claim 9, wherein said step of measuring an amperometric response comprises obtaining a cyclic voltammogram, of the aqueous sample at a scan rate of 100 mV/s.
